(19) United States
(12) Patent Application Publication
(10) Pub. No.: US 2026/0111684 A1
(43) Pub. Date: Apr. 23, 2026

(54) LOCAL LANGUAGE MODEL TUNING APPARATUS AND METHOD

(71) Applicant: ELECTRONICS AND TELECOMMUNICATIONS RESEARCH INSTITUTE, Daejeon (KR)

(72) Inventors: Chan-Sung PARK, Daejeon (KR); Yong-Wook RA, Daejeon (KR); Hwan-Seok CHUNG, Daejeon (KR)

(73) Assignee: ELECTRONICS AND TELECOMMUNICATIONS RESEARCH INSTITUTE, Daejeon (KR)

(21) Appl. No.: 19/242,054

(22) Filed: Jun. 18, 2025

(30) Foreign Application Priority Data
Oct. 22, 2024 (KR) 10-2024-0144671

(51) Int. Cl. G06F 40/40

(52) U.S. Cl. CPC G06F 40/40

(57) ABSTRACT

Disclosed herein are a local language model tuning apparatus and method. The local language model tuning apparatus is configured to align a local language model using a first split subset of a first dataset implemented as a list of pairs of a prompt and a response of a service language model, perform batch inference of obtaining a result sample by inputting a prompt recorded in a second split subset of the first dataset to the aligned local language model, evaluate performance of the aligned local language model through the service language model based on the result sample, and when an evaluation score obtained by evaluating the performance of the aligned local language model exceeds a preset threshold, deploy the aligned local language model.

### CROSS REFERENCE TO RELATED APPLICATION

This application claims the benefit of Korean Patent Application No. 10-2024-0144671, filed Oct. 22, 2024, which is hereby incorporated by reference in its entirety into this application.

### BACKGROUND OF THE INVENTION

### 1. Technical Field

The present disclosure relates generally to Artificial Intelligence (AI) language model technology, and more particularly to local language model tuning technology.

### 2. Description of the Related Art

The explosive growth of data, along with advancements in machine learning algorithms, such as transformers, and model architectures, has provided a major breakthrough in the development of a large language model. A language model, which was previously used primarily for translation or simple text processing, can now perform complex tasks in various application fields including customer service, healthcare, legal, finance, and even network configuration. Due to increased efficiency in business and industry and improved accessibility and ease of use, a service language model is being widely adopted as a general approach to incorporating an intelligence function into services, applications, or systems.

In this way, a service language model allows users and developers to utilize advanced AI technology or the like for the development of services, applications, or systems that are applicable to various fields, while saving both time and cost. However, deploying an independent service language model in real-world target environments such as services, applications, or systems comes with limitations in the application of the independent service language model due to several unpredicted issues. When failure occurs in a service language model in services, applications, or systems that are automated by designing the service language model to be heavily reliant on the services, applications or systems, all functions may be broken down. Furthermore, even if the functions of the services, applications, or systems based on the service language model have been validated, functionality integrated into the service language model may not be usable in actual deployment environments where Internet connectivity is unstable or unavailable. In particular, because calling the service language model requires sending data of a user, it becomes difficult to use the service language model in cases where data security is important or sensitive. Further, although it is possible to develop by integrating the service language model on a server-grade PC, the service language model cannot be utilized even when deployed to completely different environments, such as an actual target environment with limited resources or where internet connectivity is not easily made. Additionally, when a service provider continuously trains and updates the service language model to change the version of the service language model, prompts (inputs to the service language model) used during development may no longer work without change. That is, even if the development of services, applications or systems was completed based on a specific version of a service language model, the original prompts that were used during development cannot be utilized without change when the corresponding version of the service language model is no longer supported or when internal changes are made in the service language model to improve performance without a developer's knowledge.

Therefore, when applications or systems are developed and services are provided based on service language models, there are required an architecture and a control mechanism that enables seamless migration from a service language model to a local language model synchronized therewith in the event of unpredicted issues.

Meanwhile, U.S. Patent Publication No. US 2024/0185001 entitled “Dataset Generation Using Large Language Models” discloses a system and technology that are capable of generating datasets for training task-oriented dialogue systems.

### SUMMARY OF THE INVENTION

Accordingly, the present disclosure has been made keeping in mind the above problems occurring in the prior art, and an object of the present disclosure is to overcome various issues that may arise when a service language model is deployed in an actual target environment in order to introduce an intelligence function into services, applications or systems.

Another object of the present disclosure is to obtain a result that is as similar as possible to the output (response) obtained from a service language model for the same input (prompt) used in the service language model through a seamless transition from the service language model to a local language model synchronized with the service language model by deploying the local language model when a failure occurs in the service language model.

A further object of the present disclosure is to enable a desired service to be provided when a language model is deployed in an environment in which Internet connectivity is unavailable or in an environment completely different from a service language model deployment environment.

Yet another object of the present disclosure is to prevent issues in which data is leaked by independently operating an aligned local language model when data security is important.

Still another object of the present disclosure is to prevent the functionality of services, applications or systems from being influenced even when the version of a service language model changes or the supporting of the service language model is stopped.

In accordance with an aspect of the present disclosure to accomplish the above objects, there is provided a local language model tuning apparatus, including one or more processors, and memory configured to store at least one program that is executed by the one or more processors, wherein the at least one program is configured to align a local language model using a first split subset of a first dataset implemented as a list of pairs of a prompt and a response of a service language model, perform batch inference of obtaining a result sample by inputting a prompt recorded in a second split subset of the first dataset to the aligned local language model, evaluate performance of the aligned local language model through the service language model based on the result sample, and when an evaluation score obtained by evaluating the performance of the aligned local language model exceeds a preset threshold, deploy the aligned local language model.

The at least one program may be configured to obtain the result sample including multiple responses generated for each prompt recorded in the second split subset of the first dataset.

The at least one program may be configured to evaluate a similarity between a result sample output from the aligned local language model for the prompt recorded in the second split subset and a result sample output from the service language model.

The at least one program may be configured to request an evaluation score on the result sample from the service language model by generating a prompt that specifies evaluation criteria and a scale of evaluation scores.

The at least one program may be configured to calculate multiple evaluation scores through iterative evaluations of multiple responses generated for each prompt recorded in the second split subset of the first dataset.

The at least one program may be configured to, when the evaluation score obtained by evaluating the performance of the aligned local language model does not exceed the preset threshold, generate a second dataset through the service language model using the first split subset of the first dataset.

The at least one program may be configured to construct a prompt for generating the second dataset using the first split subset of the first dataset and to generate the second dataset by inputting the prompt for generating the second dataset to the service language model.

The at least one program may be configured to update the first dataset by adding the second dataset to the first split subset of the first dataset.

In accordance with another aspect of the present disclosure to accomplish the above objects, there is provided a local language model tuning method performed by a local language model tuning apparatus, local language model tuning method including aligning a local language model using a first split subset of a first dataset implemented as a list of pairs of a prompt and a response of a service language model, performing batch inference of obtaining a result sample by inputting a prompt recorded in a second split subset of the first dataset to the aligned local language model, evaluating performance of the aligned local language model through the service language model based on the result sample, and when an evaluation score obtained by evaluating the performance of the aligned local language model exceeds a preset threshold, deploying the aligned local language model.

Performing the batch inference may include obtaining the result sample including multiple responses generated for each prompt recorded in the second split subset of the first dataset.

Evaluating the performance may include evaluating a similarity between a result sample output from the aligned local language model for the prompt recorded in the second split subset and a result sample output from the service language model.

Evaluating the performance may further include requesting an evaluation score on the result sample from the service language model by generating a prompt that specifies evaluation criteria and a scale of evaluation scores.

Evaluating the performance may further include calculating multiple evaluation scores through iterative evaluations of multiple responses generated for each prompt recorded in the second split subset of the first dataset.

The local language model tuning method may further include, when the evaluation score obtained by evaluating the performance of the aligned local language model does not exceed the preset threshold, generating a second dataset through the service language model using the first split subset of the first dataset.

Generating the second dataset may include constructing a prompt for generating the second dataset using the first split subset of the first dataset, and then generating the second dataset by inputting the prompt for generating the second dataset to the service language model.

Generating the second dataset may include updating the first dataset by adding the second dataset to the first split subset of the first dataset.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a configuration in which a service language model according to an embodiment of the present disclosure introduces an intelligence function into a service, an application or system;

FIG. 2 is a diagram illustrating the configuration of a scenario of a local language model tuning apparatus according to an embodiment of the present disclosure;

FIG. 3 is a diagram illustrating the structure and usage of a coverage dataset and a synthetic dataset according to an embodiment of the present disclosure;

FIG. 4 is a diagram illustrating a list of input (prompt) and output (response) pairs extracted for a summarization task from a coverage dataset and a synthetic dataset according to an embodiment of the present disclosure;

FIG. 5 is a block diagram illustrating a local language model tuning apparatus according to an embodiment of the present disclosure;

FIG. 6 is a block diagram illustrating in detail an example of a sample generation unit of the batch inference unit illustrated in FIG. 5;

FIG. 7 is a diagram illustrating an example of the result of evaluation of result samples generated by the evaluation unit illustrated in FIG. 5;

FIGS. 8 and 9 are diagrams illustrating data recorded by aggregating results output from the local language model tuning apparatus according to an embodiment of the present disclosure;

FIGS. 10 and 11 are diagrams illustrating a prompt input to a service language model and a response result output therefrom according to an embodiment of the present disclosure;

FIGS. 12 to 15 are diagrams illustrating a prompt input to a service language model and synthetic data generated by the service language model so as to generate a synthetic dataset according to an embodiment of the present disclosure;

FIG. 16 is an operation flowchart illustrating a local language model tuning method according to an embodiment of the present disclosure;

FIG. 17 is an operation flowchart illustrating in detail an example of the step of iteratively generating an aligned local language model for the input of a single case among test split subsets when the number of inputs illustrated in FIG. 16 is less than the specified number of batches;

FIG. 18 is an operation flowchart illustrating in detail an example of the step of performing K iterative evaluations on each single input for evaluation when the number of inputs is less than the specified number, illustrated in FIG. 16;

FIG. 19 is an operation flowchart illustrating in detail an example of the step of generating a synthetic dataset when a specified number of synthetic datasets have not yet been generated, illustrated in FIG. 16.

FIG. 20 is a diagram illustrating a computer system according to an embodiment of the present disclosure.

### DESCRIPTION OF THE PREFERRED EMBODIMENTS

Hereinafter, the present disclosure will be described in detail with reference to the attached drawings. Repeated descriptions and descriptions of known functions and configurations which have been deemed to make the gist of the present disclosure unnecessarily obscure will be omitted below. The embodiments of the present disclosure are provided to more fully describe the disclosure to those skilled in the art. Therefore, the shapes, sizes, etc. of elements in the drawings may be exaggerated to make the description clearer.

In the specification, when an element is referred to as “comprising” or “including” a component, it does not preclude another component but may further include other components unless the context clearly indicates otherwise.

The present disclosure may be variously modified and may have various embodiments, and the embodiments are intended to be illustrated and described in detail in the accompanying drawings.

However, this is not intended to limit the present disclosure to particular modes of practice, and it is to be appreciated that all changes, equivalents, or substitutes that do not depart from the spirit and technical scope of the present disclosure are encompassed in the present disclosure.

In description of components of the embodiment of the present disclosure, terms such as first, second, A, B, (a), and (b) may be used. These terms are used merely to distinguish one component from other components, and the essentials, order, or sequence of the components are not limited by the terms.

Unless otherwise defined, all terms including technical and scientific terms used herein have the same meaning as commonly understood by one of ordinary skill in the art to which the present disclosure belongs. It will be further understood that terms used herein should be construed as having a meaning that is consistent with their meaning in the context of this specification and the relevant art and will not be interpreted in an idealized or overly formal sense unless expressly so defined herein.

It will be understood that when a component is referred to as being “associated” with another component, it can be directly associated with or connected to the other component or intervening components may be present therebetween.

The terminology used herein is intended to merely describe specific embodiments only and is not intended to limit the present disclosure. A singular expression includes a plural expression unless a description to the contrary is specifically pointed out in context. It will be further understood that the terms “comprise”, “include”, “have”, etc. when used in this specification, specify the presence of stated features, numbers, steps, operations, elements, or combinations thereof but do not preclude the possibility of the presence or addition of one or more other features, numbers, steps, operations, elements, or combinations thereof.

Hereinafter, embodiments of the present disclosure will be described in detail with reference to the attached drawings. In description of the present disclosure, independent reference numerals are used to designate the same components in the drawings to facilitate overall understanding.

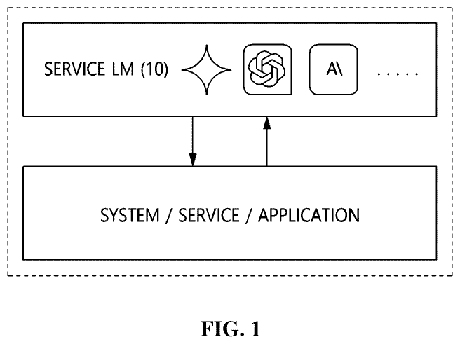

FIG. 1 is a diagram illustrating a configuration in which a service language model according to an embodiment of the present disclosure introduces an intelligence function into a service, an application or system.

Referring to FIG. 1, during a development phase, a feasibility check may be performed for use-cases of a user by introducing an intelligence function into a service, an application or a system using a service language model (LM) 10.

Hereinafter, a local language model tuning apparatus and method according to embodiments of the present disclosure are intended to describe schemes for overcoming various unpredicted issues that may occur when the service language model 10 is deployed in an actual target environment and supplementing the service language model 10.

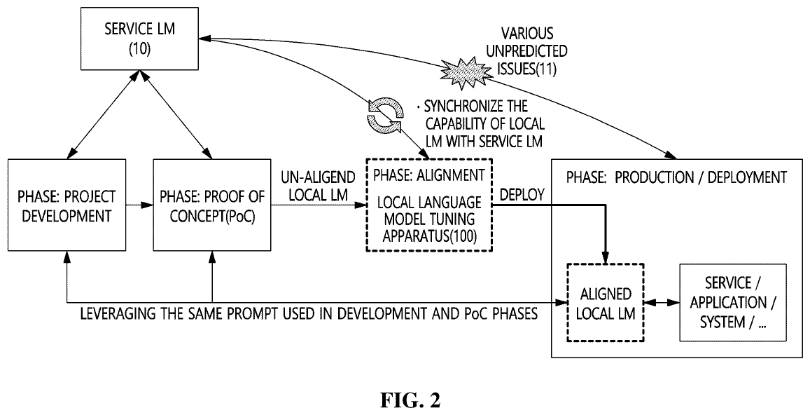

FIG. 2 is a diagram illustrating a scenario configuration of a local language model tuning apparatus according to an embodiment of the present disclosure.

Referring to FIG. 2, a service scenario is illustrated in which a local language model tuning apparatus 100 synchronizes the functionality (or capability) of a service language model 10 with that of an aligned local language model (aligned local LM), thus enabling the migration of the functionality to the aligned local LM. When only the service language model 10 is used to introduce an intelligence function into the service, application or system, various unpredicted issues 11 that may occur when a model is deployed in an actual target environment may be overcome by deploying the aligned local language model (LM) synchronized with the service language model 10.

Local language models may be divided into an unaligned local language model (unaligned local LM) and an aligned local language model (aligned local LM).

After the unaligned local language model is tuned, the local language model tuning apparatus 100 may use the same prompt as that used in the service language model 10 during a development phase or Proof-of-Concept (PoC) phase by deploying the aligned local language model.

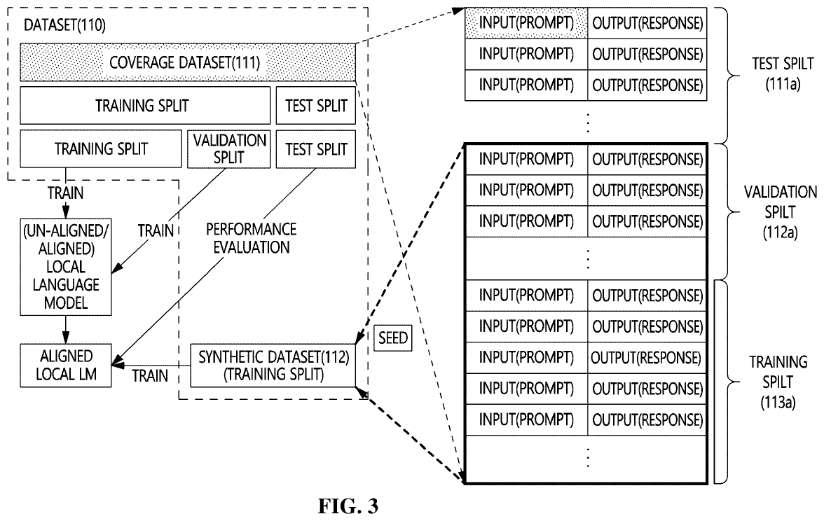

FIG. 3 is a diagram illustrating the structure and usage of a coverage dataset and a synthetic dataset according to an embodiment of the present disclosure.

Referring to FIG. 3, a dataset 110 may be composed of a coverage dataset 111 and a synthetic dataset 112.

The coverage dataset 111 is intended for tuning (e.g., fine-tuning) the local language model, and may be implemented as a list of input (prompt) and output (response) pairs (e.g., a list of internal input and output pairs in a JSON format) that are satisfied by a user while using a service language model (e.g., GPT, Gemini, or Claude).

The coverage dataset 111 may include a test split subset 111a, a validation split subset 112a, and a training split subset 113a.

The test split subset 111a may be used to perform comparison and validation as to how well the fine-tuned local language model operates.

The validation split subset 112a may be used to fine-tune results during the training of a language model.

Also, the validation split subset 112a may be used as a seed for generating the synthetic dataset 112 required for aligning subdivided language models.

The training split subset 113a may be used to train local language models including an unaligned local language model and an aligned local language model having insufficient performance.

Also, the training split subset 113a may become a seed for generating the synthetic dataset 112 used to tune local language models.

The synthetic dataset 112 generated in this way may be implemented only as the training split subset 113a.

The case where evaluated performance does not exceed any preset threshold when the performance of the local language model is evaluated based on the service language model 10 through the test split subset 111a may occur due to the insufficiency of the training split subset 113a and the difference between the input (prompt) and output (response) structures of the training split subset 113a and the test split subset 111a. Performance degradation caused by the insufficiency of the training split subset 113a implies that the training split subset 113a can serve as the seed of the synthetic dataset due to the lack of the training split subset 113a.

In order to overcome performance degradation caused by the differences in input (prompt) and output (response) structures, the training split subset 113a needs to be generalized to the test split subset 111a, but an overfitting problem may additionally occur when the language model is directly trained with the test split subset 111a. Therefore, a synthetic dataset may be additionally generated such that the validation split subset 112a formed similarly to the test split subset 111a is utilized as a seed for generating the synthetic dataset 112 to include the structure of the test split subset 111a.

For example, the division ratio of the training split subset 113a/validation split subset 112a/test split subset 111a may be manually or automatically determined to be a ratio of 8:1:1 or the like, and this is only an embodiment for convenience of description and is not limited to a specific division ratio.

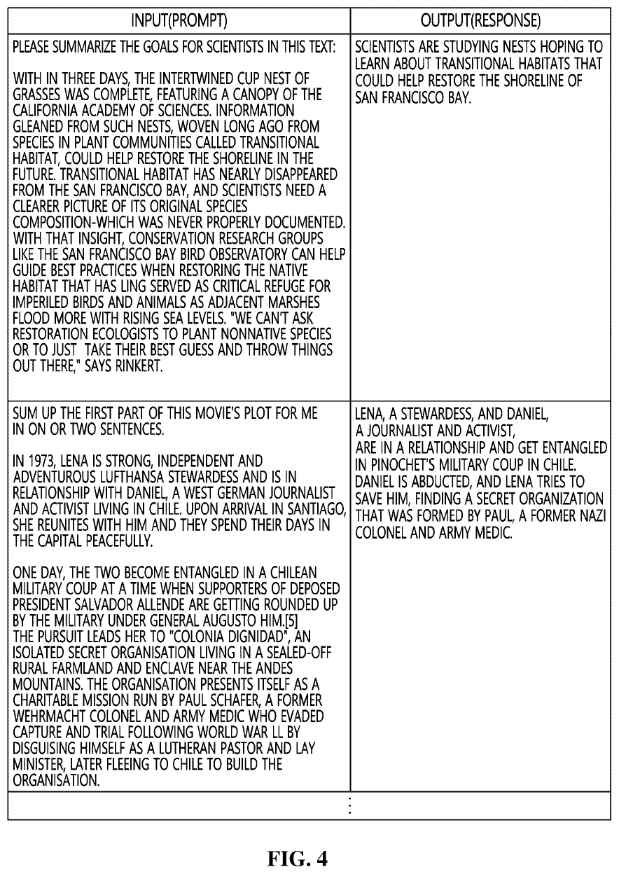

FIG. 4 is a diagram illustrating a list of input (prompt) and output (response) pairs extracted for a summarization task from a coverage dataset and a synthetic dataset according to an embodiment of the present disclosure.

Referring to FIG. 4, it can be seen that a list of input (prompt) and output (response) pairs extracted for a summary task from a coverage dataset and a synthetic dataset that are implemented as structured data as in the case of a JSON format is depicted.

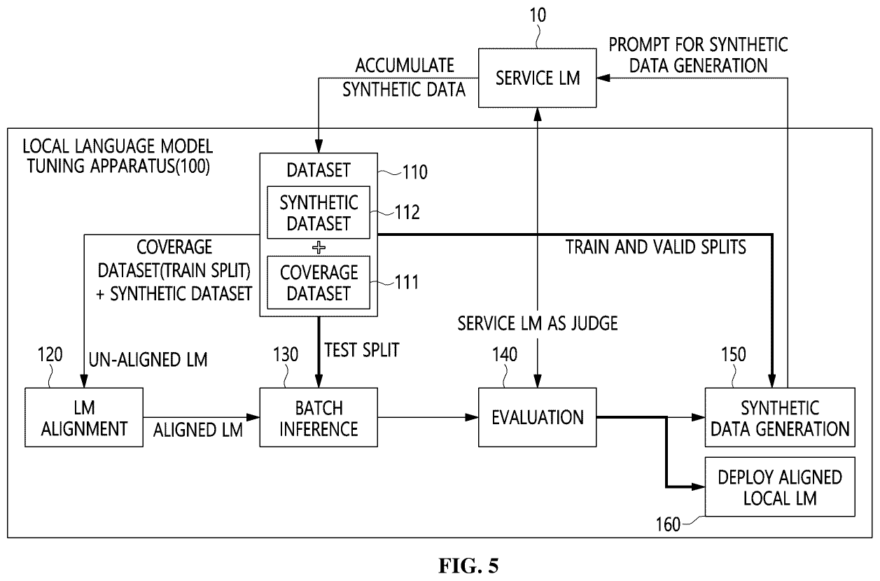

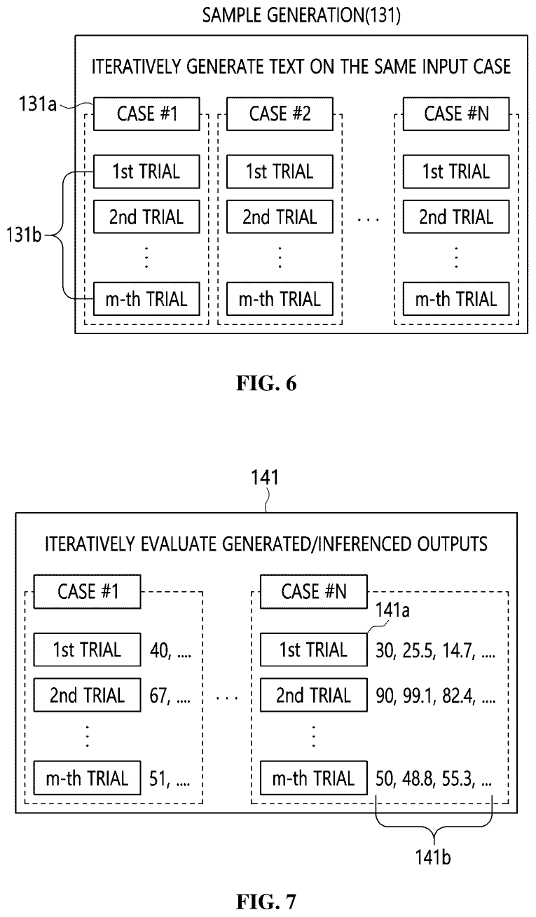

FIG. 5 is a block diagram illustrating a local language model tuning apparatus according to an embodiment of the present disclosure. FIG. 6 is a block diagram illustrating in detail an example of a sample generation unit in the batch inference unit illustrated in FIG. 5. FIG. 7 is a diagram illustrating an example of the result of evaluation of result samples generated by the evaluation unit illustrated in FIG. 5.

Referring to FIG. 5, the components of the local language model tuning apparatus 100 for aligning a local language model using a coverage dataset 111 and a synthetic dataset 112 are illustrated. The local language model tuning apparatus 100 according to the embodiment of the present disclosure may include a dataset management unit 110, a language model (LM) alignment unit 120, a batch inference unit 130, an evaluation unit 140, a synthetic data generation unit 150, and an aligned local language model deployment unit (Deploy Aligned local LM) 160.

The language model (LM) alignment unit 120, the batch inference unit 130, the evaluation unit 140, and the synthetic data generation unit 150 may be configured in a four-stage pipeline.

The dataset management unit 110 may manage the coverage dataset 111 and the synthetic dataset 112.

Here, the dataset management unit 110 may manage the coverage dataset 111 in the form of training/validation/test split subsets.

The dataset management unit 110 may transfer the training split subset of the coverage dataset 111 and the synthetic dataset 112 implemented as only a training split subset to the language model alignment unit 120.

The language model alignment unit 120 may align local language models using the training split subset of the coverage dataset 111 implemented as a list of prompt and response pairs of the service language model 10.

Here, the language model alignment unit 120 may tune (i.e., fine-tune) an unaligned local language model and an aligned local language model having insufficient performance in accordance with the purpose thereof.

Here, the language model alignment unit 120 may first perform alignment using only the training split subset of the coverage dataset 111.

The term “alignment” may refer to tuning or training each language model so that the language model is operated in accordance with a given objective or criterion.

For example, in the case of each language model, alignment is a process of allowing the language model to respond in accordance with specific user requirements, an ethical criterion, or a specific task. Such alignment may make the output of the corresponding language model be more useful and reliable.

An alignment process may typically include data selection, tuning of a training scheme, the evaluation of results, and the modification of the model based on feedback. The local language model aligned in this way may respond or behave in a way that is more suitable for the specific objective.

Thereafter, when it is determined by the evaluation unit 140 that the performance of the aligned local language model is lower than a preset threshold, the language model alignment unit 120 may additionally perform alignment of the language model by adding the training split subset of the coverage dataset 111 to the synthetic dataset 112 to be subsequently generated.

The language model alignment unit 120 may transfer the aligned local language model to the batch inference unit 130.

The batch inference unit 130 may perform batch inference of inputting a prompt recorded in the test split subset of the coverage dataset 111 to the aligned local language model and obtaining a result sample.

Here, the batch inference unit 130 may generate a result sample including multiple responses generated for each prompt by inputting inputs (prompts) recorded in the test split subset of the coverage dataset 111 to the aligned local language model.

Due to the characteristics of language models, a response may change at each time even for the same input (prompt), and it may be difficult to derive an answer exactly matching the output (response) recorded in the test split subset of the coverage dataset 111.

Referring to FIG. 6, the sample generation unit 131 of the batch inference unit 130 may iterate the process of deriving a result sample from the corresponding local language model M times for each input (prompt). In detail, in the sample generation unit 131, case #1 to case #N (131a) may represent individual inputs recorded in the test split subset of the coverage dataset 111, and a 1st trial to an m-th trial (131b) may represent M results generated by the aligned local language model (LM) for each corresponding input (prompt) in each of the cases from case #1 to case #N (131a).

It can be seen that each case 131a corresponds to the single input prompt of the coverage dataset 111. It can also be seen that each trial 131b corresponds to a single output generated by the aligned local language model for a given case (input prompt).

The evaluation unit 140 may evaluate the performance of the aligned local language model through the service language model 10 based on the result sample.

In this case, the evaluation unit 140 may evaluate the similarity between a result sample output from the aligned local language model and a result sample output from the service language model 10, for each prompt recorded in the test split subset.

The evaluation unit 140 may evaluate the performance of the aligned language model through the service language model 10 based on the results of sample outputs, corresponding to n prompt inputs * m trials for each individual input, which are generated by the batch inference unit 130.

Here, the evaluation unit 140 may request evaluation scores on the result samples from the service language model 10 by generating prompts that specify evaluation criteria and the scale of evaluation scores.

Here, the evaluation unit 140 may calculate multiple evaluation scores through iterative evaluation of multiple responses generated for each prompt recorded in the test split subset of the coverage dataset 111.

Referring to FIG. 7, evaluation results 141 output from the evaluation unit 140 are depicted. Each trial 141a may be evaluated k times.

Individual numerals in the corresponding trial may represent evaluation scores (k trials) 141b, evaluated by the service language model. For example, examples of the evaluation scores 141b may include a similarity score, other scores, etc.

Here, the evaluation method by the evaluation unit 140 may be changed depending on the type of prompt input to the service language model 10.

For example, the evaluation unit 140 may evaluate the similarity between the sample output of the service language model 10 and the sample output generated by the batch inference unit 130, which correspond to input recorded in the test split subset of the coverage dataset 111.

Here, the evaluation unit 140 may request the evaluation scores from the service language model 10 by generating prompts that include evaluation criteria based on which evaluation is desired to be performed, and that specify a desired scheme such as the scale of evaluation scores (e.g., 0.0 to 1.0, or 0 to 100).

For example, because responses cannot be equal to each other in each time although they may be similar to some degree due to the characteristics of language modes, the evaluation unit 140 may iteratively perform k evaluations for each individual sample output among all of (n * m) sample outputs.

Here, the evaluation unit 140 may also determine a final score by averaging the results of k evaluations for each individual sample output. This is only an embodiment, and thus a method for determining a preset threshold depending on a scenario such as by considering an outlier or the like including the average scores may be changed.

When the evaluation score, obtained by evaluating the performance of the aligned local language model, does not exceed the preset threshold, the synthetic data generation unit 150 may generate a synthetic dataset through the service language model using at least one of the training split subset or the validation split subset of the coverage dataset, or a combination thereof.

Here, the synthetic data generation unit 150 may construct a prompt for generating the synthetic dataset using at least one of the training split subset or the validation split subset, or a combination thereof, and may then generate the synthetic dataset by inputting the prompt for generating the synthetic dataset to the service language model.

Here, when a result score, obtained by evaluating each individual sample output by the evaluation unit 140, does not exceed the preset threshold, the synthetic data generation unit 150 may reference the training split subset or the validation split subset of the coverage dataset 111 of the dataset management unit 110 as seed data in order to generate the synthetic dataset 112.

Here, the synthetic data generation unit 150 may construct the prompt to be input to the service language model 10 from the referenced seed data.

A scheme for constructing the prompt does not have a fixed format, and may vary with a use case. However, the synthetic data generation unit 150 may construct a prompt to be input to the service language model 10 by referencing the inputs (prompts) and the outputs (responses) obtained from the training split subset or the validation split subset of the coverage dataset 111 of FIG. 3.

When the result score of evaluating each individual sample output by the evaluation unit 140 exceeds a preset threshold, the aligned local language model deployment unit 160 may deploy the aligned local language model (LM) after fixing the version of the aligned local LM.

When a failure occurs in the service language model, the local language model tuning apparatus 100 according to the embodiment of the present disclosure may provide a result that is as similar as possible to output (response) obtained from the service language model for the same input (prompt) used in the service language model by deploying the local language model synchronized with the service language model. Furthermore, the local language model tuning apparatus 100 may generate a result sample corresponding to the response of the aligned local language model for the input of a batch structure including an arbitrary number of cases (i.e., N cases). In this case, the local language model tuning apparatus 100 may extending the number of inputs for language model evaluation to (N*M) through iterative generation of response samples up to an arbitrary number of times (i.e., M times) for each input (prompt) during the derivation of result samples of the aligned local language model, thus providing the enhancement of evaluation performance of the aligned local language model.

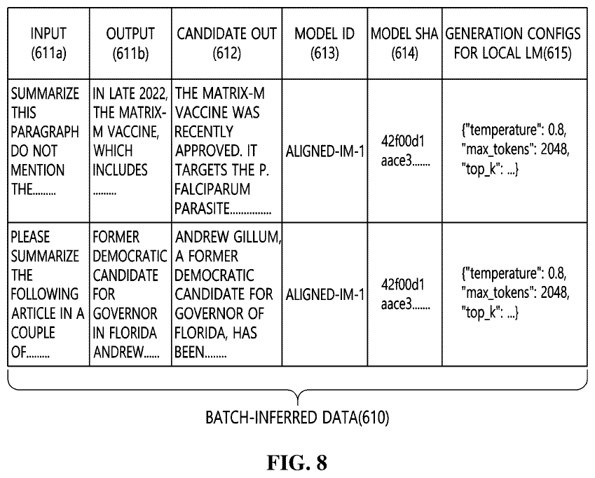

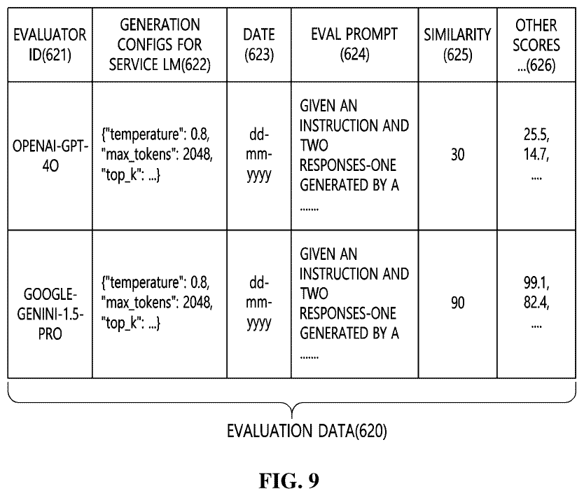

FIGS. 8 and 9 are diagrams illustrating data recorded by aggregating results output from the local language model tuning apparatus according to an embodiment of the present disclosure.

Referring to FIGS. 8 and 9, it can be seen that a detailed structure of data recorded by allowing the local language model tuning apparatus 100 to aggregate the output results of the batch inference unit 130 and the evaluation unit 140 is depicted.

Batch-inferred data 610 illustrated in FIG. 8 may represent output results for a test split subset, generated by the batch inference unit 130. Evaluation data 630 illustrated in FIG. 9 represents the output results of the evaluation unit 140.

The total number of pieces of data recorded in FIGS. 8 and 9 may be n (number of inputs)*m(number of trials)*k(number of iterative evaluations). The batch-inferred data 610 may be defined as the output of the aligned local language model (LM) for the test split subset of the coverage dataset 111.

The evaluation data 620 may be obtained by allowing the service language model 10 to directly view the batch-inferred data 610 or to evaluate the batch-inferred data 610 with reference to the reference ID thereof and then define an evaluation result as scored index data.

The batch-inferred data 610 may include the following fields. Input and output fields 611a and 611b may be filled with a list of input (prompt) and output (response) pairs from the test split subset of the coverage dataset 111. In a candidate output field 612, result samples generated by the aligned local LM for input by the batch inference unit 130 may be recorded. A model ID field 613 to a model Secure Hash Algorithm (SHA) field 614 may include identification information of the aligned local LM which generates the candidate output field 612. Since a model in the same model repository can be updated several times, the model SHA field 614 may include hash information for identifying a committed specific model. A field 615 for generation configurations (configs) for the local LM 615 is composed of parameters (i.e., temperature, max tokens, top k, top p, . . . ) used to control a scheme for generating the candidate output field 612. In the field 615 for generation configs for the local LM, configuration information used to generate the candidate output field 612 may be recorded.

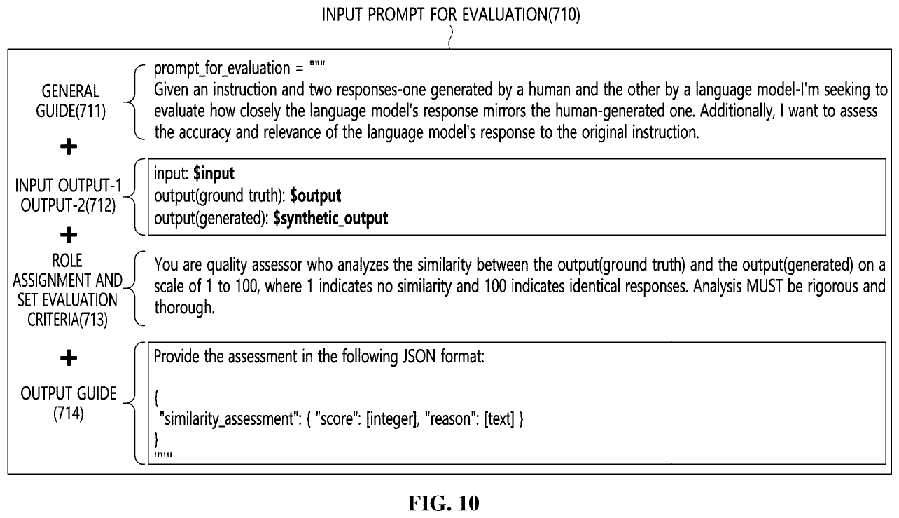

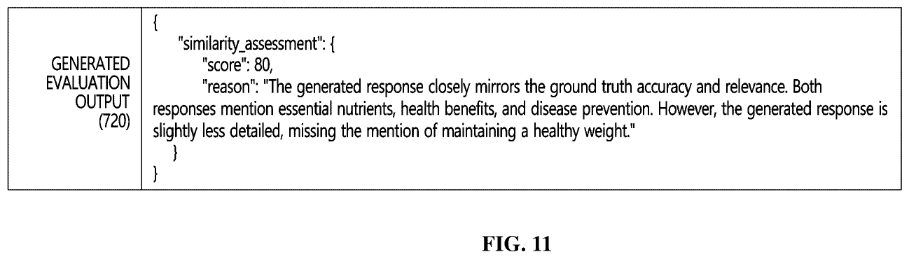

The evaluation data 620 may include the following fields. An evaluator ID field 621 may include model information (e.g., GPT4) of the service language model 10 which evaluates the local language model. A field 622 for generation configurations for the service language model (generation configs for service LM) may be composed of parameters (i.e., temperature, max tokens, top k, top p, . . . ) used to control a scheme for generating evaluation results. Because it may be difficult to exactly identify the service language model 10 using only the model information (e.g., GPT4) due to the characteristics of a service in which an enhancement task is internally performed even if content in the evaluator ID field 621 is the same, a date field 623 may include evaluation date for identifying the version of the service language model 10 that is used. In an evaluation prompt field (Eval prompt) 624, actual prompts to be input to the service language model 10 may be recorded. The evaluation prompt field 624 may include all strings constituting examples of an input prompt 710 for evaluation illustrated in FIG. 10. In a similarity score field 625 and a field 626 for other scores, results evaluated by the service language model 10 may be recorded. Depending on the scheme for configuring the evaluation prompt field (Eval prompt) 624, evaluation criteria may be guided in a desired manner. In an embodiment, the result of the similarity score field 625 indicates evaluation scores that can be obtained from examples of the input prompt 710 for evaluation in FIG. 10. It can be seen that the degree of the similarity between the output for the input prompt 710 for evaluation in FIG. 10 and the result value of the candidate output field 612 is represented by a score ranging from 0 to 100.

FIGS. 10 and 11 are diagrams illustrating a prompt input to a service language model and a response result output therefrom according to an embodiment of the present disclosure.

Referring to FIG. 10, it can be seen that the prompt 710 input to a service language model 10 and a response result (evaluation output) 720 output from the service language model in order to evaluate output generated by an aligned local language model according to an embodiment of the present disclosure are depicted.

The local language model tuning apparatus 100 may compare output generated by the local language model with the output of the test split subset of the coverage dataset, and may then inject the value of the batch-inferred data 610 of FIG. 8 in the form of a template using a placeholder so as to control the generation of an evaluation result. Symbol $ in the input/output-1/output-2 field 712 of the input prompt 710 may represent a placeholder, and may be replaced with the value of the batch-inferred data 610 that is extracted. The general guide field 711 of the input prompt 710 may include information that is a basis for derivation of the evaluation result from the service language model 10. That is, the general guide field 711 may include descriptions and instructions for the Input/Output-1/Output-2 field 712. The value of the batch-inferred data 610 may be injected into the Input/Output-1/Output-2 field 712 in the form of a template using the placeholder. Input is the input field 611a of the batch-inferred data 610, and Output-1 is used as a ground truth and is the output field 611b of the batch-inferred data 610. Output-2 is the result sample generated by the local language model and may fill the placeholder with the candidate output field 612 of the batch-inferred data 610. A role assignment and set evaluation criteria field 713 provides guidance for quality assessment (e.g., similarity, precision, etc.) of evaluation results to be generated by the service language model 10. Such guidance may be provided within a range of assessment scores (e.g., 1 to 100 or 0 to1.0, etc.). An output guide field 714 may guide the output format of evaluation results to be generated by the service language model 10.

Referring to FIG. 10, the response result (generated evaluation output) 720 may represent an output result generated by the service language model 10, and may show an evaluation result when specified as similarity and output format in JSON, depending on the guidance of the role assignment and set evaluation criteria field 713 and the output guide field 714 provided from the prompt 710 input to the service language model 10.

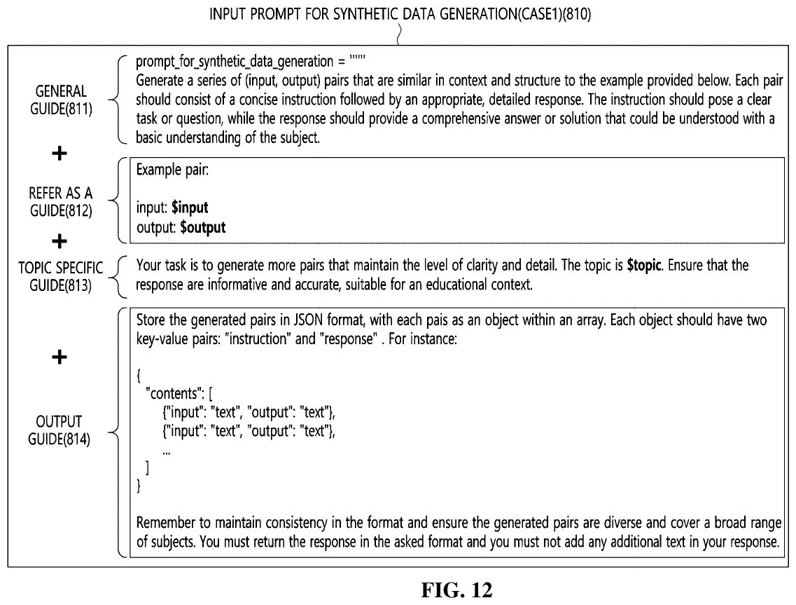

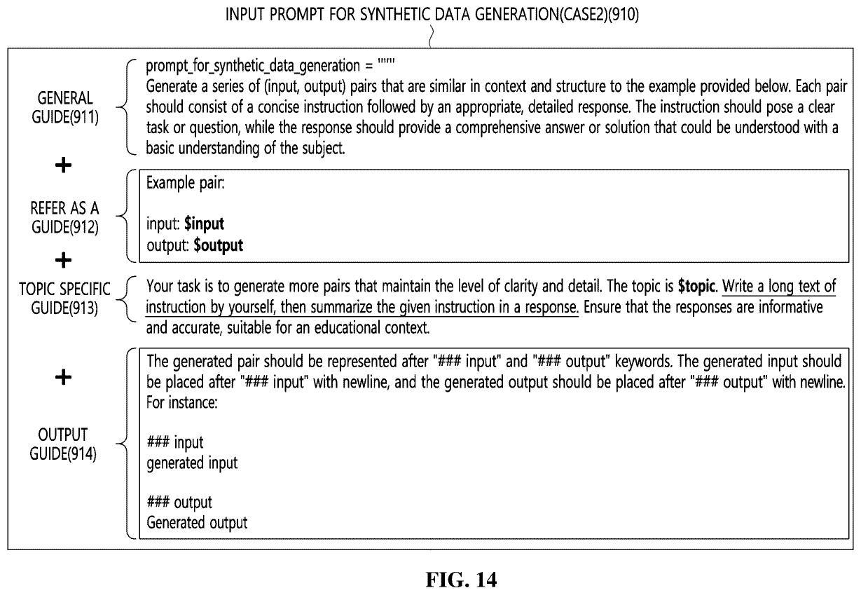

FIGS. 12 to 15 are diagrams illustrating a prompt input to a service language model and synthetic data generated by the service language model so as to generate a synthetic dataset according to an embodiment of the present disclosure.

Referring to FIGS. 12 to 15, a prompt 810 or 910 input to a service language model 10 and synthetic data 820 or 920 generated by the service language model 10 depending on the output guide to generate synthetic data 112 according to an embodiment of the present disclosure are depicted.

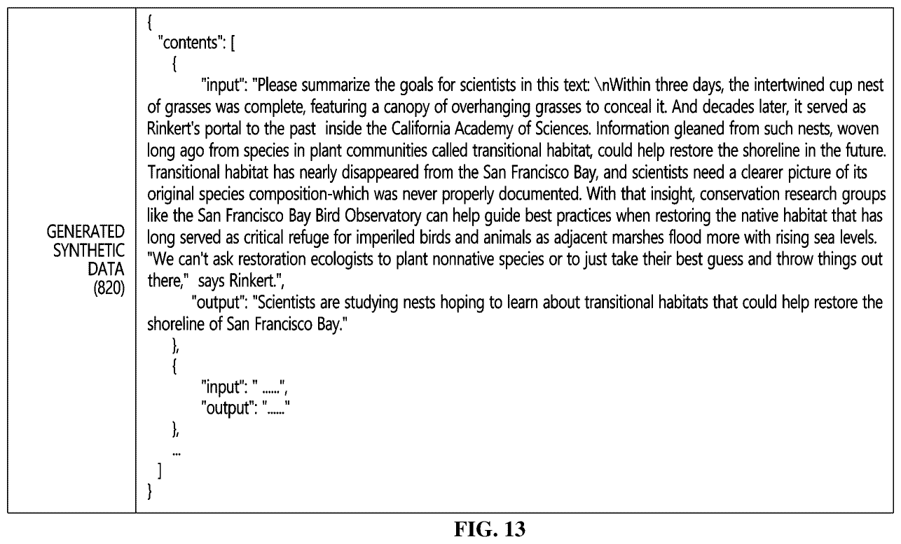

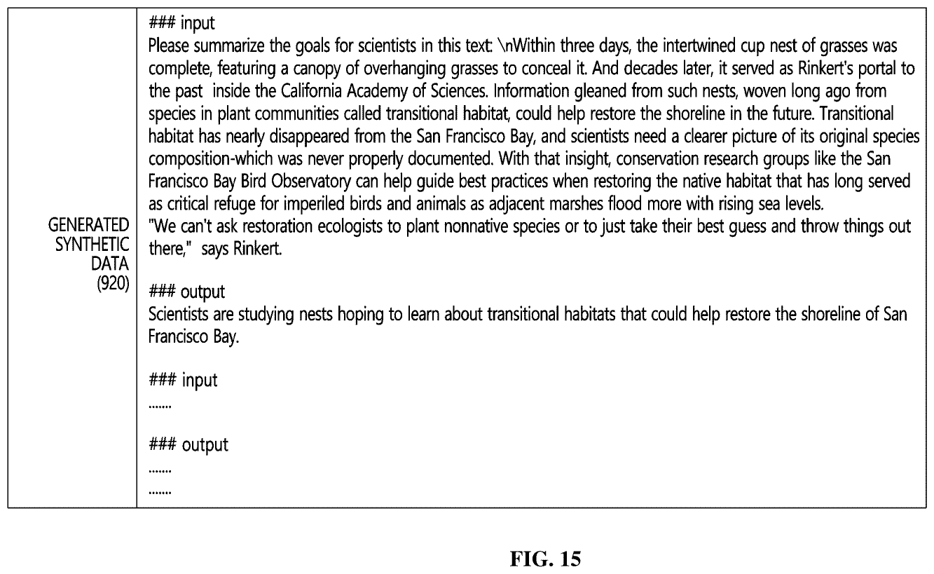

Each of general guide fields 811 and 911 may include information that is a basis for outputting synthetic data from the service language model 10. That is, the corresponding general guide field may include descriptions and instructions for a corresponding one of input and outputs fields 812 and 912. In the input prompts 810 and 910, symbol $ indicates a placeholder, guidance reference fields (“refer as a guide” fields) 812 and 912 serve as instructions, which may provide the input/output of the coverage dataset 111 as samples and generate synthetic datasets under the guidance of the output guide fields (output guide) 814 and 914. $input and $output in the guide reference fields (refer as a guide) 812 and 912 may be replaced with the actual input (prompt) and output (response) values of the training split subset and the validation split subset of the coverage dataset 111 included in the batch-inferred data 610. $topic in topic specific guide fields 813 and 913 may be replaced with a specific topic depending on the guidance as to which type of synthetic data (e.g., summary, coding, CLI, analysis, ...) is to be generated. It can be seen that the synthetic data 820 of FIG. 13 is synthetic data obtained when the output guide 814 of the input prompt (case 1) 810 to generate synthetic data is specified as the format of JSON. It can be seen that the synthetic data 920 of FIG. 15 is synthetic data obtained when the delimiter ###is specified in the output guide 914 of the input prompt (case 2) 910 to generate synthetic data. Such embodiments show that the form of the input prompts 810 and 910 may be tuned using various methods for each task, and the methods are not limited to specific methods.

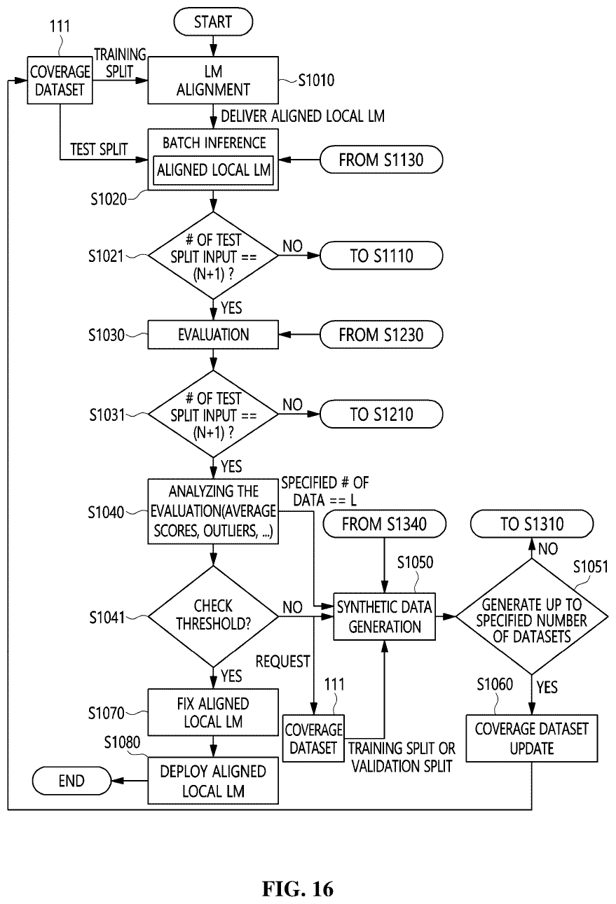

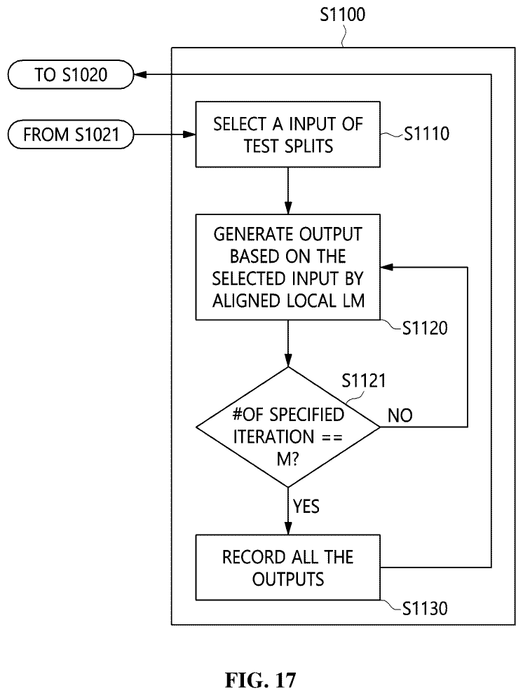

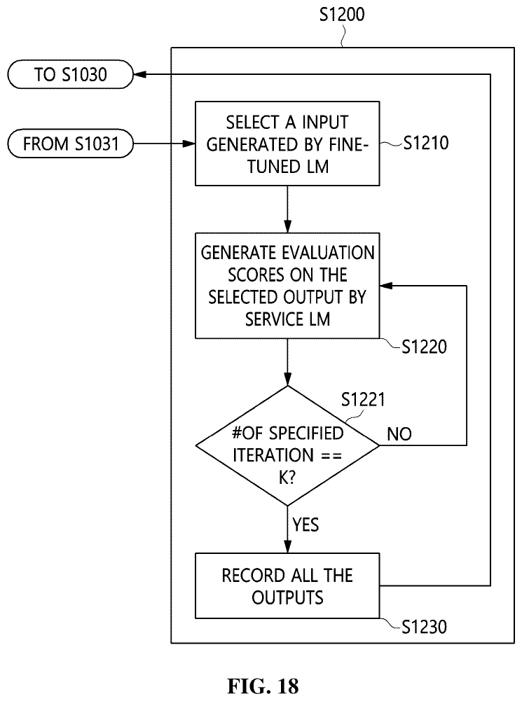

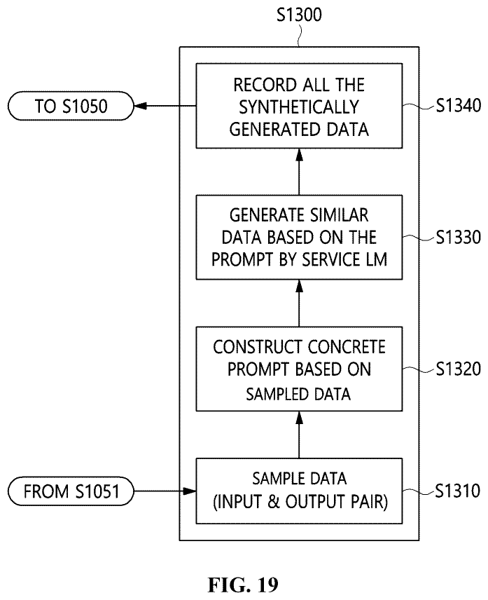

FIG. 16 is an operation flowchart illustrating a local language model tuning method according to an embodiment of the present disclosure. FIG. 17 is an operation flowchart illustrating in detail an example of the step of iteratively generating an aligned local language model for the input of a single case among test split subsets when the number of inputs illustrated in FIG. 16 is less than the specified number of batches. FIG. 18 is an operation flowchart illustrating in detail an example of the step of performing K iterative evaluations on each single input for evaluation when the number of inputs is less than the specified number, illustrated in FIG. 16. FIG. 19 is an operation flowchart illustrating in detail an example of the step of generating a synthetic dataset when a specified number of synthetic datasets have not yet been generated, illustrated in FIG. 16.

FIGS. 16 to 19 are flowcharts illustrating the overall process of generating a synthetic dataset and then re-performing alignment on the generated synthetic dataset when a local language model (Local LM) satisfying a coverage dataset is aligned and the performance of the aligned local language model cannot exceed a preset threshold. In the flowcharts of the present disclosure, symbol #and number may be used to have the same meaning and may be used interchangeably with each other.

Referring to FIG. 16, at step S1010, local language models may be aligned using the training split subset of a coverage dataset 111 implemented as a list of prompt and response pairs of a service language model.

Here, at step S1010, an aligned local language model (LM) that does not satisfy the performance threshold of an unaligned local language model and requires re-tuning may be tuned with an input training split subset.

At step S1020, batch inference for the aligned local language model may be performed using the test split subset delivered from the coverage dataset 111.

Here, at step S1020, batch inference of inputting a prompt recorded in the test split subset of the coverage dataset 111 to the aligned local language model and obtaining a result sample may be performed.

Here, at step S1020, a result sample including multiple responses generated for each prompt recorded in the test split subset of the coverage dataset 111 may be obtained.

Here, step S1020 may be performed such that batch-inferred data 610 may be generated through a sample generation unit 131 according to an embodiment of the present disclosure from the aligned local language model (aligned local LM) using the test split subset delivered from the coverage dataset 111.

At step S1021, whether batch inference has been performed a preset arbitrary number (N) of times to perform a batch task, and whether the number of inputs of the test split subset in the coverage dataset 111 is (N+1) may be checked.

At step S1021, when batch inference has not been performed N times identical to the preset number of batches and the number of inputs is less than (N+1), a result sample on which batch inference is iterated M times for one input case of the test split subset may be generated at step S1110.

Referring to FIG. 17, at step S1100, the aligned local language model (Aligned Local LM) iterates a generation process M times on the input (prompt) of a single case from the test split subset having the input of N cases of the coverage dataset 111 and then generates a result.

At step S1110, in order to iterate a generation process M times for N inputs (prompts) for a single case from the test split subset at step S1021, a single input (prompt) may be selected from the test split subset.

At step S1120, a sample output may be generated based on the input (prompt) selected through the aligned local language model (LM).

At step S1121, whether the generation process has been iteratively performed a specified number of times (e.g., M times) may be checked, and all sample outputs may be recorded when the iterative performance has been completed at step S1130.

At step S1130, after all sample outputs have been recorded, batch inference for the aligned local language model may be performed at step S1020.

On the other hand, when the generation process has not yet been iteratively performed M times at step S1121, step S1120 of generating sample output based on a selected input (prompt) through the aligned local language model (LM) may be iterated.

Referring back to FIG. 16, at step S1021, when the number of inputs has reached (N+1) exceeding N that is the preset number of batches, evaluation may be performed from received batch-inferred data 610 at step S1030.

At step S1030, the performance of the aligned local language model may be evaluated through the service language model 10 based on the result sample.

Here, at step S1030, the similarity between a result sample output from the aligned local language model and a result sample output from the service language model 10, for each prompt recorded in the test split subset, may be evaluated.

Here, at step S1030, multiple evaluation (or assessment) scores may be calculated through iterative evaluation of multiple responses generated for each prompt recorded in the test split subset of the coverage dataset 111.

Here, at step S1030, evaluation scores on the result samples may be requested from the service language model 10 by generating prompts that specify evaluation criteria and the scale of evaluation scores.

Here, at step S1030, an evaluation task may be performed through the service language model 10 based on the batch-inferred data 610 for N (number of generated prompt inputs)*M(number of trials for each input).

At step S1031, whether the number of inputs in the batch-inferred data 610 is (N*M+1) may be checked by performing evaluation up to a preset arbitrary number of times (N*M) for the evaluation task.

Furthermore, at step S1031, when evaluation up to the preset arbitrary number of times (N*M) is not performed and the number of inputs is less than (N*M+1), K iterative evaluations may be performed for each single input for evaluation at step S1210.

Referring to FIG. 18, at step S1200, a result evaluated K times by the service language model 10 may be generated to evaluate a single result selected from among (N M) result samples generated by the batch inference unit 130.

At step S1210, a single result sample generated by the aligned local LM may be selected in order for the service language model 10 to iteratively evaluate the single result sample, selected from among the input (N*M) result samples, K times.

At step S1220, evaluation scores on the single result may be generated by the service language model 10.

At step S1221, whether iterative evaluations have been performed a specified number of times (e.g., K times) may be checked.

At step S1221, whether K iterative evaluations have been completed, the outputs of all evaluation scores may be recorded at step S1230.

At step S1230, when recording of the outputs of all evaluation scores is completed, evaluation may be performed on the batch-inferred data 610 at step S1030.

Further, at step S1221, when K iterative evaluations have not yet been completed, step S1220 where the service language model 10 generates evaluation scores may be iterated.

Referring back to FIG. 16, when the number of inputs exceeds (N*M) that is the preset number of inputs for evaluation and then reaches (N*M+1) at step S1031, the evaluation result may be analyzed at step S1040.

At step S1040, the average scores of all scores in a table (for all of N*M inputs) and outliers (preset ranges required to generate M outputs of batch inference for one input case) may be analyzed, and abnormal values falling out of the outliers may be dropped.

At step S1041, the thresholds of evaluation indices other than the outliers may be checked.

At step S1041, when the evaluation result satisfies any preset thresholds, the version of the aligned local language model may be fixed at step S1070.

At step S1070, the version of the aligned local language model may be fixed.

At step S1080, a fixed version of the aligned local language model may be deployed.

Further, when the evaluation result does not satisfy the thresholds of the evaluation indices other than the outliers at step S1041, the generation of synthetic data may be requested at step S1050.

Here, at step S1041, after the training split subset or validation split subset of the coverage dataset 111 is requested, the generation of synthetic data may be requested to generate a synthetic dataset at step S1050.

At step S1050, when an evaluation score, obtained by evaluating the performance of the aligned local language model, does not exceed a preset threshold, a synthetic dataset may be generated through the service language model 10 using at least one of the training split subset or the validation split subset of the coverage dataset 111, or a combination thereof.

At step S1050, a prompt for generating the synthetic dataset may be constructed using the training split subset of the coverage dataset, and the prompt for generating the synthetic dataset may be input to the service language model, thus generating the synthetic dataset.

At step S1050, information about the specified number (e.g., L) of synthetic datasets to be generated may be received so as to generate a specified number of synthetic datasets.

When a specified number (e.g., L) of synthetic datasets are generated at step S1051, the generated synthetic datasets may be added to the training split subset of the coverage dataset, thus updating the coverage dataset at step S1060.

At step S1060, the synthetic datasets may be added to the training split subset of the coverage dataset, thus updating the coverage dataset.

At step S1060, step S1010 may be iterated through the training split subset of the generated synthetic datasets.

At step S1060, when the generated synthetic datasets are added to the validation split subset, the distribution of the validation split subset designed similarly to the test set may be unstable to deteriorate the utility of the generated synthetic datasets, and thus the coverage dataset may be updated by adding the synthetic datasets to the validation split subset and the test split subset of the coverage dataset.

Furthermore, when a specified number of synthetic datasets have not yet been generated at step S1051, a synthetic dataset may be generated at step S1310.

Referring to FIG. 19, at step S1300, it can be seen that a synthetic dataset is generated through the construction of a control prompt for synthetic dataset generation and the service language model 10.

At step S1310, data may be sampled from the training split subset or validation split subset of the coverage dataset 111.

Here, the data described at step S1310 may refer to a pair of input (prompt) and output (response).

At step S1320, a concreted prompt to be input to the service language model 10 may be constructed based on sampled data.

At step S1330, similar synthetic data may be generated based on the prompt input to the service language model 10.

At step S1340, all of synthetically generated data (generated synthetic data) may be recorded, after which the process returns to step S1050.

At step S1050, a number of synthetic datasets corresponding to any threshold number (e.g., L) transferred at step S1040 may be generated. When the number of generated synthetic datasets is not sufficient and the result is determined to be poor at step S1030, synthetic datasets may be additionally generated.

The local language model tuning method illustrated in FIGS. 16 to 19 may extend the number of inputs to (N*M), and iteratively perform evaluation K times for a single input to evaluate the aligned language model, thus providing a method for enabling fine-tuning to be performed on the local language model by obtaining evaluation scores on (N*M*K) aligned language models and generating synthetic datasets.

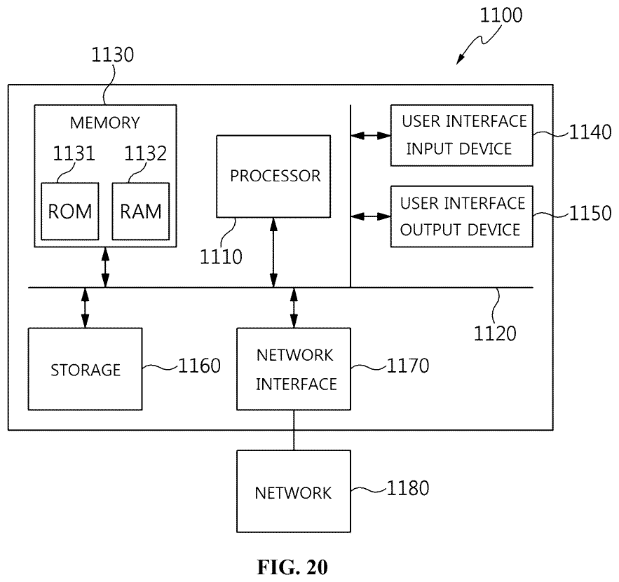

FIG. 20 is a diagram illustrating a computer system according to an embodiment of the present disclosure.

Referring to FIG. 20, a local language model tuning apparatus 100 according to an embodiment of the present disclosure may be implemented in a computer system 1100 such as a computer-readable storage medium. As illustrated in FIG. 20, the computer system 1100 may include one or more processors 1110, memory 1130, a user interface input device 1140, a user interface output device 1150, and storage 1160, which communicate with each other through a bus 1120. The computer system 1100 may further include a network interface 1170 connected to a network 1180. Each processor 1110 may be a Central Processing Unit (CPU) or a semiconductor device for executing processing instructions stored in the memory 1130 or the storage 1160. Each of the memory 1130 and the storage 1160 may be any of various types of volatile or nonvolatile storage media. For example, the memory 1130 may include Read-Only Memory (ROM) 1131 or Random Access Memory (RAM) 1132.

A local language model tuning apparatus according to an embodiment of the present disclosure may include one or more processors 1110, and memory 1130 configured to store at least one program that is executed by the one or more processors 1110, wherein the at least one program is configured to align a local language model using a first split subset of a first dataset implemented as a list of pairs of a prompt and a response of a service language model, perform batch inference of obtaining a result sample by inputting a prompt recorded in a second split subset of the first dataset to the aligned local language model, evaluate performance of the aligned local language model through the service language model based on the result sample, and when an evaluation score obtained by evaluating the performance of the aligned local language model exceeds a preset threshold, deploy the aligned local language model.

The at least one program may be configured to obtain the result sample including multiple responses generated for each prompt recorded in the second split subset of the first dataset.

The at least one program may be configured to evaluate a similarity between a result sample output from the aligned local language model for the prompt recorded in the second split subset and a result sample output from the service language model.

The at least one program may be configured to request an evaluation score on the result sample from the service language model by generating a prompt that specifies evaluation criteria and a scale of evaluation scores.

The at least one program may be configured to calculate multiple evaluation scores through iterative evaluations of multiple responses generated for each prompt recorded in the second split subset of the first dataset.

The at least one program may be configured to, when the evaluation score obtained by evaluating the performance of the aligned local language model does not exceed the preset threshold, generate a second dataset through the service language model using the first split subset of the first dataset.

The at least one program may be configured to construct a prompt for generating the second dataset using the first split subset of the first dataset and to generate the second dataset by inputting the prompt for generating the second dataset to the service language model.

The at least one program may be configured to update the first dataset by adding the second dataset to the first split subset of the first dataset.

The present disclosure may overcome various issues that may arise when a service language model is deployed in an actual target environment in order to introduce an intelligence function into services, applications or systems.

Further, the present disclosure may obtain a result that is as similar as possible to the output (response) obtained from a service language model for the same input (prompt) used in the service language model through a seamless transition from a service language model to a local language model by deploying the local language model synchronized with the service language model when failure occurs in the service language model.

Furthermore, the present disclosure may enable a desired service to be provided when a language model is deployed in an environment in which Internet connectivity is unavailable or in an environment completely different from a service language model deployment environment.

Furthermore, the present disclosure may prevent issues in which data is leaked by independently operating an aligned local language model when data security is important.

Furthermore, the present disclosure may prevent the functionality of services, applications or systems from being influenced even when the version of a service language model changes or the supporting of the service language model is stopped.

As described above, in the local language model tuning apparatus and method according to the present disclosure, the configurations and schemes in the above-described embodiments are not limitedly applied, and some or all of the above embodiments can be selectively combined and configured such that various modifications are possible.

What is claimed is:

1. A local language model tuning apparatus, comprising:
one or more processors; and
a memory configured to store at least one program that is executed by the one or more processors,
wherein the at least one program is configured to:
align a local language model using a first split subset of a first dataset implemented as a list of pairs of a prompt and a response of a service language model,
perform batch inference of obtaining a result sample by inputting a prompt recorded in a second split subset of the first dataset to the aligned local language model,
evaluate performance of the aligned local language model through the service language model based on the result sample, and
when an evaluation score obtained by evaluating the performance of the aligned local language model exceeds a preset threshold, deploy the aligned local language model.

2. The local language model tuning apparatus of claim 1, wherein the at least one program is configured to obtain the result sample including multiple responses generated for each prompt recorded in the second split subset of the first dataset.

3. The local language model tuning apparatus of claim 1, wherein the at least one program is configured to evaluate a similarity between a result sample output from the aligned local language model for the prompt recorded in the second split subset and a result sample output from the service language model.

4. The local language model tuning apparatus of claim 3, wherein the at least one program is configured to request an evaluation score on the result sample from the service language model by generating a prompt that specifies evaluation criteria and a scale of evaluation scores.

5. The local language model tuning apparatus of claim 4, wherein the at least one program is configured to calculate multiple evaluation scores through iterative evaluations of multiple responses generated for each prompt recorded in the second split subset of the first dataset.

6. The local language model tuning apparatus of claim 1, wherein the at least one program is configured to, when the evaluation score obtained by evaluating the performance of the aligned local language model does not exceed the preset threshold, generate a second dataset through the service language model using the first split subset of the first dataset.

7. The local language model tuning apparatus of claim 6, wherein the at least one program is configured to construct a prompt for generating the second dataset using the first split subset of the first dataset and to generate the second dataset by inputting the prompt for generating the second dataset to the service language model.

8. The local language model tuning apparatus of claim 7, wherein the at least one program is configured to update the first dataset by adding the second dataset to the first split subset of the first dataset.

9. A local language model tuning method performed by a local language model tuning apparatus, comprising:
aligning a local language model using a first split subset of a first dataset implemented as a list of pairs of a prompt and a response of a service language model;
performing batch inference of obtaining a result sample by inputting a prompt recorded in a second split subset of the first dataset to the aligned local language model;
evaluating performance of the aligned local language model through the service language model based on the result sample; and
when an evaluation score obtained by evaluating the performance of the aligned local language model exceeds a preset threshold, deploying the aligned local language model.

10. The local language model tuning method of claim 9, wherein performing the batch inference comprises:
obtaining the result sample including multiple responses generated for each prompt recorded in the second split subset of the first dataset.

11. The local language model tuning method of claim 9, wherein evaluating the performance comprises:
evaluating a similarity between a result sample output from the aligned local language model for the prompt recorded in the second split subset and a result sample output from the service language model.

12. The local language model tuning method of claim 11, wherein evaluating the performance further comprises:
requesting an evaluation score on the result sample from the service language model by generating a prompt that specifies evaluation criteria and a scale of evaluation scores.

13. The local language model tuning method of claim 12, wherein evaluating the performance further comprises:
calculating multiple evaluation scores through iterative evaluations of multiple responses generated for each prompt recorded in the second split subset of the first dataset.

14. The local language model tuning method of claim 9, further comprising:
when the evaluation score obtained by evaluating the performance of the aligned local language model does not exceed the preset threshold, generating a second dataset through the service language model using the first split subset of the first dataset.

15. The local language model tuning method of claim 14, wherein generating the second dataset comprises:
constructing a prompt for generating the second dataset using the first split subset of the first dataset, and then generating the second dataset by inputting the prompt for generating the second dataset to the service language model.

16. The local language model tuning method of claim 15, wherein generating the second dataset comprises:
updating the first dataset by adding the second dataset to the first split subset of the first dataset.
